(19) United States
(12) Patent Application Publication
(10) Pub. No.: US 2008/0267607 A1
(43) Pub. Date: Oct. 30, 2008

(54) IMAGE PICKUP APPARATUS AND ELECTRONIC DEVICE

(75) Inventor: Naomi Mori, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/059,832

(22) Filed: Mar. 31, 2008

(30) Foreign Application Priority Data
Apr. 24, 2007 (JP) 2007-114329

(51) Int. Cl. G03B 13/02; H04N 5/225

(52) U.S. Cl. 396/374; 348/333.01; 348/E05.024

(57) ABSTRACT

An image pickup apparatus includes an eyepiece portion and a touch panel, and controls execution of a predetermined action in a condition where a photographer contacts the touch panel and its contact position is in a predetermined area. The predetermined area is changed in accordance with a condition of whether or not an object is near the eyepiece portion.

### BACKGROUND OF THE INVENTION

1. Field of the Invention

The present invention relates to image pickup apparatuses and electronic devices having touch panels.

2. Description of the Related Art

Hitherto, setting of a camera, instruction of photographing, and the like, have been operated through operation members such as buttons and dials provided at a camera.

In order to decrease the size of a camera, and to increase the size of a display unit, Japanese Patent Laid-Open No. 6-70206 suggests a technique in which a touch panel is provided on the front surface of a display unit instead of the operation member. A user contacts the touch panel with the user's finger according to a display of such as an operation button to operate the camera.

Also, in order to facilitate the operation of the touch panel, Japanese Patent Laid-Open No. 11-164175 suggests a technique in which a pressed position on a touch panel when a camera is held is determined, and operation buttons are arranged around the pressed position.

With an image pickup apparatus having a display unit with a touch panel, and a viewfinder, when a photographer performs photographing while looking though the viewfinder, the photographer cannot look at the display unit.

With the above-described techniques, the photographer may incorrectly operate the touch panel (for example, for changing an aperture, or a shutter speed) through an operation using the touch panel while looking through the viewfinder.

### SUMMARY OF THE INVENTION

An aspect of the present invention provides an image pickup apparatus having an eyepiece portion. The image pickup apparatus includes a touch panel unit configured to display at least an image or a character and detect a contact position of a photographer, a control unit configured to control execution of a predetermined action if the contact position of the photographer detected by the touch panel unit is in a predetermined area, and an object detection unit configured to detect whether or not an object is near the eyepiece portion. The control unit changes the predetermined area in accordance with the detection of whether or not the object is near the eyepiece portion by the object detection unit.

Further features of the present invention will become apparent from the following description of exemplary embodiments with reference to the attached drawings.

### BRIEF DESCRIPTION OF THE DRAWINGS

FIG. 1 is an example block diagram showing an image pickup apparatus, according to an exemplary embodiment of the present invention.

FIG. 2 is a flowchart showing an example main routine, according to an exemplary embodiment of the present invention.

FIG. 3 is a flowchart showing an example action when an eye is detected, according to an exemplary embodiment of the present invention.

FIG. 4 is a flowchart showing an example action in FIG. 3, according to an exemplary embodiment of the present invention.

FIG. 5 is an illustration showing an example of the back surface of the image pickup apparatus, according to an exemplary embodiment of the present invention.

FIG. 6 is an illustration showing an example display of a viewfinder of the image pickup apparatus, according to an exemplary embodiment of the present invention.

### DESCRIPTION OF THE EMBODIMENTS

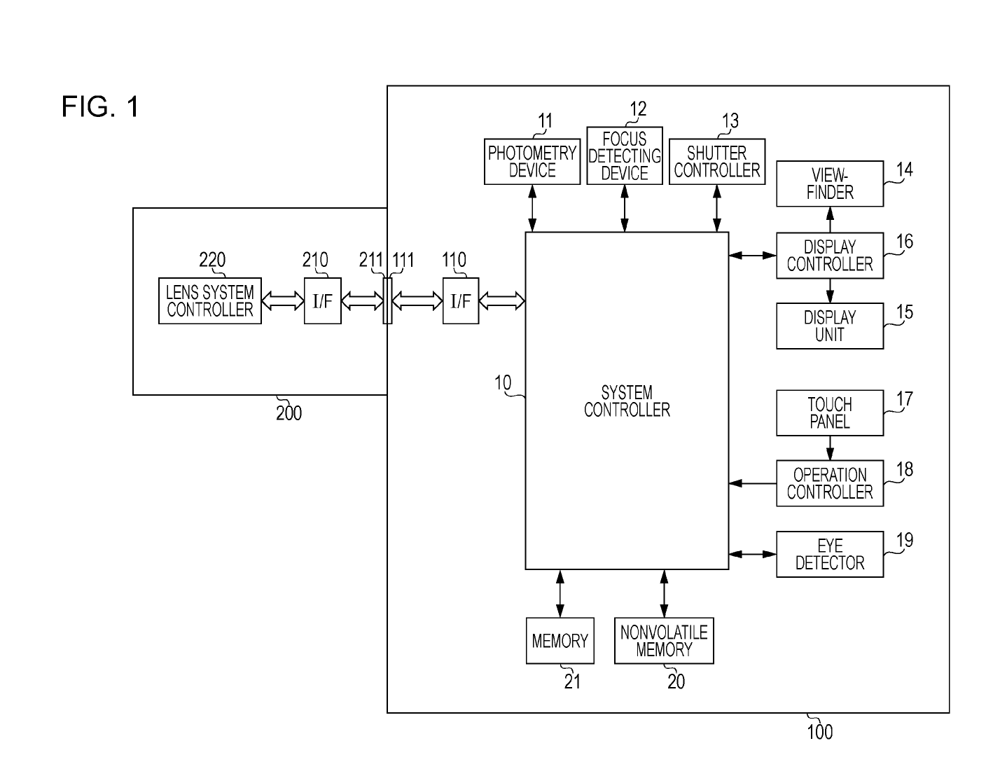

Embodiments, features and aspects of the present invention are herein now described below with reference to the drawings. FIG. 1 is an example block diagram showing an image pickup apparatus according to the embodiment.

Reference numeral 10 denotes a system controller, which is, for example, a CPU, to control a whole image processing unit 100. Reference numeral 11 denotes a photometry device, 12 denotes a focus detecting device, and 13 denotes a shutter controller. Reference numeral 14 denotes a viewfinder capable of displaying operation items and the like. A photographer looks through the viewfinder 14. Reference numeral 15 denotes a display unit capable of displaying an image, a character, a number, and the like. In particular, the display unit 15 displays a photographed image, operation items, and the like. Reference numeral 16 denotes a display controller that controls the display unit 15 to display an image, and controls the viewfinder 14 and the display unit 15 to display an active state, a message, and the like, by using a character, an image, and the like, in accordance with execution of a program in the system controller 10. The display contents of the display controller 16 include, for example as ones to be displayed in the viewfinder 14, an in-focus display, a shutter speed display, an aperture display, an exposure correction display, an ISO display, a display of the number of photographable images, and the like.

The display contents of the display controller 16 include, for example as ones to be displayed on the display unit 15, a photographed image display, a setting change menu display, a setting confirmation display, an error display, a date and time display, and the like. Reference numeral 17 denotes a touch panel including a sensor that detects a contact of the photographer with an operation member, such as a finger, a nail, or a touch pen. The photographer can perform various operations through a contact on the touch panel 17.

Also, the touch panel 17 is provided with the display unit 15. The photographer can operate the touch panel 17 while looking at the display unit 15. Accordingly, for the operation of the touch panel 17, the display unit 15 displays a contact position on the touch panel 17 by the photographer, the control content, and the like. Hence, the photographer can instruct a desired control through an operation according to the display. An operation controller 18 receives, when the photographer performs a contact operation on the touch panel 17, a contact position on the touch panel 17, that is, coordinate information on the touch panel 17. The operation controller 18 detects a continuous change in the contact position on the basis of the change in the received coordinate information.

The operation controller 18 sends the contact operation or the continuous change in the contact position to the system controller 10. The system controller 10 executes an action on the basis of the sent information, so that the image pickup apparatus can execute an action as instructed by the photographer. The system controller 10 determines an effective input area of the touch panel 17. When the contact position through the contact operation by the photographer is in an effective input area, the system controller 10 controls a predetermined action associated with the effective input area.

An eye detector 19 detects whether the photographer looks through the viewfinder 14 or the photographer is away from the viewfinder 14, that is, whether or not the photographer is near the viewfinder 14. The detection may use a method in which an infrared sensor is provided near the viewfinder 14, and it is detected whether or not the face of the photographer is near the viewfinder 14, on the basis of a change in infrared detection.

For example, the display content on the display unit 15 may be changed, or the display unit 15 may be turned ON or OFF, in accordance with the detection result of the eye detector 19.

In particular, when the photographer looks through the viewfinder 14, if the display unit 15 is arranged near the viewfinder 14, the photographer may feel that the display unit 15 is too bright. Hence, the display unit 15 may be turned OFF when the eye detector 19 detects a looking-through action (presence of an eye, or an object) of the photographer to the viewfinder 14. This can effectively reduce the brightness.

Reference numeral 20 denotes a nonvolatile memory such as an electrically erasable programmable read-only memory (EEPROM). The nonvolatile memory 20 can electrically delete or record data. For example, the nonvolatile memory 20 stores setting values such as a shutter speed, and an aperture. The setting values are changed by rewriting data on the nonvolatile memory 20. A memory 21 stores a constant, a variable, a program, and the like, for the action of the system controller 10. The system controller 10 executes the action by reading such data.

A below-described flowchart relating to the embodiment is stored in the memory 21 as a program. The system controller 10 reads and executes the program to exercise the flowchart.

A lens unit 200 illustrated is an interchangeable lens attachable from the outside. The lens unit 200 may be alternatively arranged in the image processing unit 100. A lens system controller 220 controls the whole lens unit 200. Interfaces 110 and 210 are for connection between the lens unit 200 and the image processing unit 100. Connectors 111 and 211 electrically connect the image processing unit 100 and the lens unit 200.

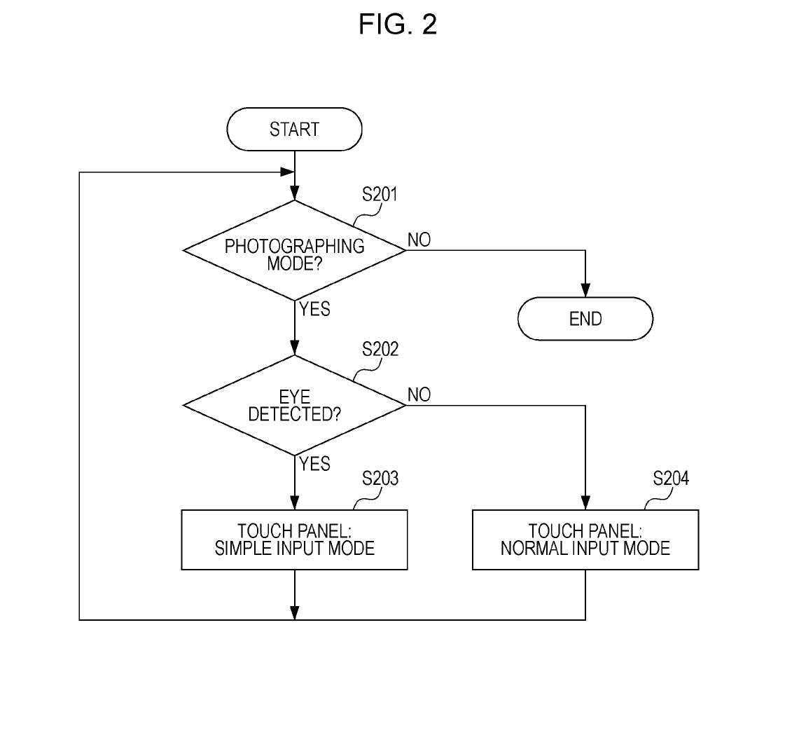

Next, the operation according to the embodiment is described with reference to FIGS. 2 to 4. FIG. 2 is a flowchart showing a main routine of the embodiment. When the image pickup apparatus starts the action through power activation or the like, it is determined whether or not the image pickup apparatus is in a photographing mode (S201). If the image pickup apparatus is in the photographing mode, it is determined whether or not the eye detector 19 detects an eye of the photographer located near the viewfinder (S202). If it is detected that the eye of the photographer is near the viewfinder, the input mode of the touch panel is set to a simple input mode, in which the photographer can easily operate the touch panel while looking through the viewfinder (S203), and then the procedure returns to S201.

In contrast, if it is not detected that the eye of the photographer is near the viewfinder in S202, the input mode of the touch panel is set to a normal input mode, in which the photographer operates the touch panel while looking at the display unit (S204), and then the procedure returns to S201. If it is determined that the input mode is not in the photographing mode in S201, the procedure is ended.

In the flowchart in FIG. 2, the input mode of the touch panel is selected in accordance with the detection of whether or not the eye of the photographer is near the viewfinder in S202.

If the input mode of the touch panel is set to the simple input mode in S203, an effective input area may be expanded, or the number of control items may be reduced, in comparison with the normal input mode so that the photographer can operate the touch panel correctly even when the eye of the photographer is near the viewfinder.

Accordingly, in the simple input mode, the effective input area of the touch panel may be a whole area of the touch panel, or the number of control items may be one. For example, in a case where photographing is instructed through a contact operation on the touch panel instead of a shutter button, if it is detected that the eye of the photographer is near the viewfinder, the effective input area is applied to the whole area of the touch panel to provide only a control item for photographing. With this setting, the photographing can be instructed merely by a contact at a desired position on the touch panel. Therefore, even when the photographer operates the touch panel while looking through the viewfinder, a situation of losing a photographing opportunity because a given contact position for photographing is not contacted, can be reduced.

For example, the effective input area may be expanded to the whole area, and upper and lower portions of the touch panel may be allocated to zooming in and zooming out, respectively. Accordingly, the photographer can easily operate the touch panel even while looking through the viewfinder.

If the input mode is set to the simple input mode in S203, a contact operation may be performed at a desired position in the effective input area of the touch panel.

To realize this, a predetermined contact operation on the touch panel by the photographer is associated with a given control, so that the predetermined contact operation is recognized as the given control when the photographer performs the predetermined contact operation. It is noted that the position of the contact operation may be a desired position in the effective input area.

Accordingly, if the photographer performs the predetermined contact operation, the operation is recognized as the given input, and hence, the image pickup apparatus performs the previously associated given control. The contact operation can be performed at a desired position in the effective input area of the touch panel without limitation of the position of the contact operation by the user. Accordingly, the photographer can easily operate the touch panel.

Also, if a plurality of contact operations are respectively associated with a plurality of control items, the photographer can instruct the plurality of control items by performing contact operations at desired positions in the effective input area.

By setting the simple input mode with one of the methods described above, or by combining the methods described above, the photographer can easily operate the touch panel even when looking through the viewfinder. Alternatively, a user may customize the simple input mode as desired.

For example, when the input mode of the touch panel is the simple input mode, the effective input area of the touch panel may be the whole area of the touch panel, and a predetermined contact operation may be performed by the photographer without limitation of the contact position on the touch panel by the photographer. In this case, since the photographer can operate the touch panel by performing the predetermined contact operation at a desired position on the touch panel, the photographer can easily operate the touch panel while looking through the viewfinder.

As described above, when it is detected that the eye of the photographer is near the viewfinder, and the input mode of the touch panel is set to the simple input mode, the photographer can easily operate the touch panel.

Therefore, the photographer can correctly operate the touch panel even though the photographer looks through the viewfinder and hence the photographer cannot look at the display unit, that is, even though the photographer does not follow the instruction on the display unit.

Referring back to the flowchart in FIG. 2, it is continuously determined whether or not the eye of the photographer is near the viewfinder while the photographing mode is selected. When the detection result is changed, the input mode of the touch panel is changed. The present invention, however, is not limited thereto. For example, the flow may be split depending on whether the power of the image pickup apparatus is ON or OFF. In this case, it is continuously detected whether or not the eye of the photographer is near the viewfinder while the power of the image pickup apparatus is ON. When the detection result is changed, the input mode of the touch panel is changed.

Also, the display unit 15 may be turned OFF when it is detected that the eye of the photographer is near the viewfinder in S202. Alternatively, the display unit 15 may be turned ON when it is not detected that the eye of the photographer is near the viewfinder in S202.

Further, the name of the control item to be controlled and the setting value of the control item may be displayed in the viewfinder so that the photographer looking through the viewfinder can recognize the control item.

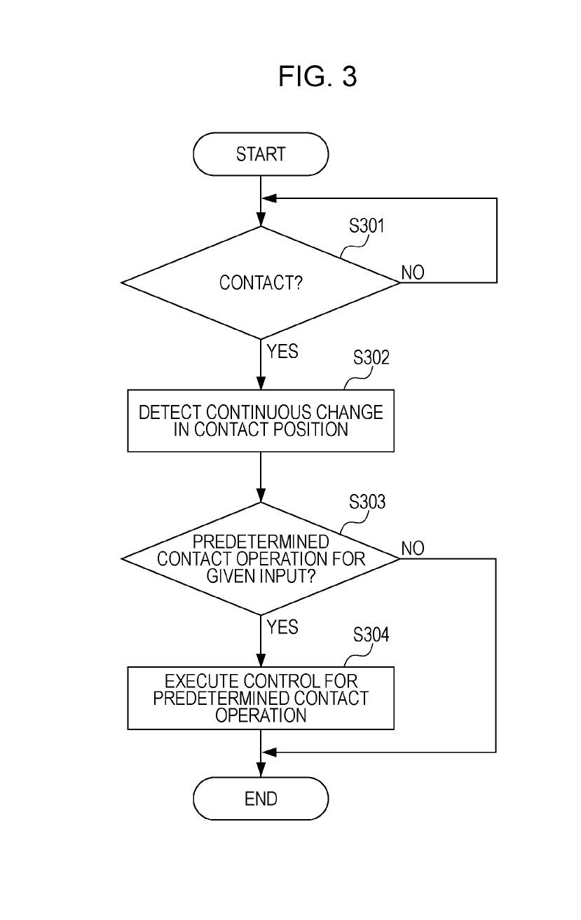

FIG. 3 is a flowchart showing an example action when the image pickup apparatus according to the embodiment of the invention is set to the simple input mode in S203 in FIG. 2.

In FIG. 3, in the simple input mode, it is assumed that the image pickup apparatus is controlled through a predetermined contact operation at a desired position in the effective input area of the touch panel by the photographer.

While it is detected that the eye of the photographer is near the viewfinder, it is determined whether or not the photographer contacts the touch panel (S301). If the photographer contacts the touch panel, a continuous change in the contact position through the contact operation is detected (S302).

Based on the result detected in S302, it is determined whether or not the photographer performs a predetermined contact operation recognized as a given input in the effective input area of the touch panel (S303). It is noted that the position of the contact operation by the photographer may be a desired position in the effective input area of the touch panel.

If it is determined that the operation is not the predetermined contact operation in S303, the action is ended. If it is determined that the operation is the predetermined contact operation in S303, a control corresponding to the predetermined contact operation is performed (S304).

For example, in a case where the predetermined operation is set on the basis of a moving direction of the contact position when the photographer keeps the contact and moves the contact position, the photographer may perform a slide operation while the photographer contacting a desired position in the effective input area of the touch panel.

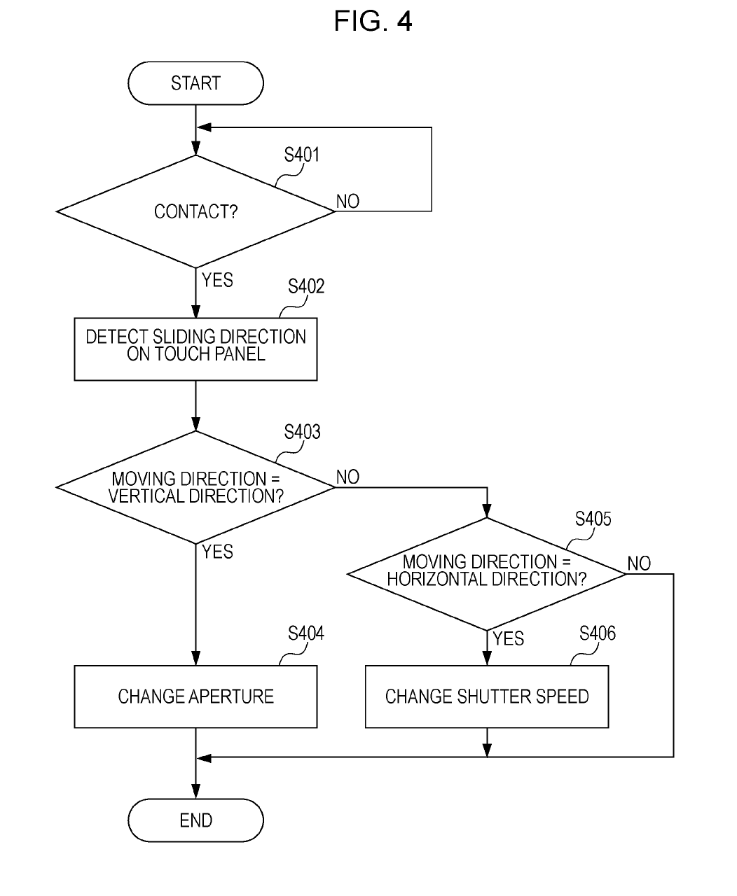

FIG. 4 is an example flowchart in FIG. 3. The predetermined contact operation to be recognized as a given input is a sliding operation in the vertical or horizontal direction while the photographer contacting the touch panel. The control associated with the operation may be changing of an aperture or a shutter speed.

It is assumed that the effective input area of the touch panel is the whole area of the touch panel.

While it is detected that the eye of the photographer is near the viewfinder, it is determined whether or not the photographer contacts the touch panel (S401). If the photographer contacts the touch panel, it is detected which direction the contact position slides while the photographer contacting the touch panel (S402).

It is determined whether or not the moving direction detected in S402 is “vertical” (S403), and if it is “vertical”, the aperture stored in the nonvolatile memory 20 is changed (S404). If the moving direction detected in S402 is not “vertical”, it is determined whether or not the moving direction is “horizontal” (S405), and if it is “horizontal”, the shutter speed stored in the nonvolatile memory 20 is changed (S406).

In S405, if the moving direction detected in S402 is other than “horizontal”, the procedure of the flowchart is ended.

According to the flow, the photographer can perform a slide operation while contacting a desired position on the touch panel. The photographer can thus operate the touch panel even while looking through the viewfinder.

In S404 and S406 of the flowchart in FIG. 4, the control contents can be set more specifically in accordance with the moving direction. For example, the aperture may be increased when the sliding operation is aimed from the lower side to the upper side, and the aperture may be decreased when the sliding operation is aimed from the upper side to the lower side.

Also, a moving distance of the slide operation by the photographer may be detected in S402. The moving distance may be associated with the amount of change in the setting value. For example, the setting value may be changed by a larger amount as the moving distance is larger.

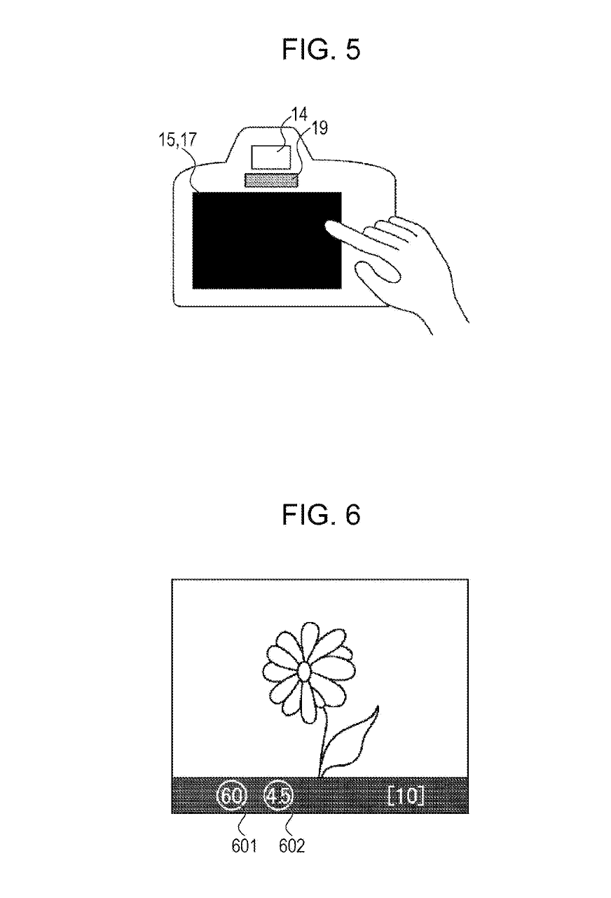

FIG. 5 is an illustration showing an example of the back surface of the image pickup apparatus. It is assumed that the image pickup apparatus follows the operation in FIG. 4.

When the photographer looks through the viewfinder 14, effective control items are displayed in the viewfinder 14.

Major members arranged on the back surface of the image pickup apparatus in FIG. 5 include the viewfinder 14, the display unit 15, the touch panel 17, and the eye detector 19.

When the photographer looks through the viewfinder 14, the eye detector 19 detects that the eye is near the viewfinder 14, and the display unit 15 is turned OFF. The eye of the photographer is located near the viewfinder 14 when the photographer looks through the viewfinder 14, and therefore, the viewfinder 14 is identified as an eyepiece portion in this embodiment. When the photographer comes away from the viewfinder 14, the eye detector 19 detects that the eye is away from the viewfinder 14, and the display unit 15 is turned ON.

While it is detected that the eye of the photographer is near the viewfinder 14, if the finger of the photographer slides on the touch panel 17 in the vertical direction, the aperture is changed, and then the value displayed in the viewfinder 14 is updated. If the finger slides in the horizontal direction, the shutter speed is changed, and then the value displayed in the viewfinder 14 is updated.

FIG. 6 illustrates an example display of the viewfinder 14. Reference numeral 601 denotes a shutter speed, and 602 denotes an aperture. The displays of the shutter speed 601 and the aperture 602 are changed in accordance with the operation by the photographer, and the result of the photometry.

In this embodiment, the predetermined contact operation on the touch panel as a given input when it is detected that the eye of the photographer is near the viewfinder, the moving operation in the vertical or horizontal direction is described as an example operation. However, the present invention is not limited thereto. For example, various operations such as an operation like a dial operation, i.e., a clockwise or counterclockwise rotation operation, may be set as a predetermined operation.

Also, in this embodiment, the control items to be controlled in accordance with the predetermined operation are the aperture and the shutter speed as examples. However, the present invention is not limited thereto. Various control items, such as a focus detecting point, a white balance, and a zoom, may be controlled.

The predetermined contact operation described above may be associated with the control item to be controlled as desired by the user. Thus, the customized operation can be provided.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-114329 filed Apr. 24, 2007, which is hereby incorporated by reference herein in its entirety.

1. An image pickup apparatus having an eyepiece portion, the apparatus comprising:
a touch panel unit configured to display at least an image or a character and detect a contact position of a photographer;
a control unit configured to control execution of a predetermined action if the contact position of the photographer detected by the touch panel unit is in a predetermined area; and
an object detection unit configured to detect whether or not an object is near the eyepiece portion,
wherein the control unit changes the predetermined area in accordance with the detection of whether or not the object is near the eyepiece portion by the object detection unit.

2. An image pickup apparatus having an eyepiece portion, the apparatus comprising:
a touch panel unit configured to display at least an image or a character and detect a contact position of a photographer;
a control unit configured to control an action of the image pickup apparatus in accordance with the contact position of the photographer detected by the touch panel unit; and
an object detection unit configured to detect whether or not an object is near the eyepiece portion,
wherein the control unit changes an acceptable area for a contact operation of the photographer on the touch panel unit, in accordance with the detection of whether or not the object is near the eyepiece portion by the object detection unit.

3. An image pickup apparatus having an eyepiece portion, the apparatus comprising:
a touch panel unit configured to display at least an image or a character and detect a contact position of a photographer;
a control unit configured to control execution of a predetermined action if the contact position of the photographer detected by the touch panel unit is in a predetermined area; and
an object detection unit configured to detect whether or not an object is near the eyepiece portion,
wherein the control unit sets the predetermined area to be large if the object detection unit detects that the object is near the eyepiece portion, as compared with the predetermined area set if the object detection unit does not detect that the object is near the eyepiece portion.

4. An electronic device comprising:
a touch panel unit configured to display at least an image or a character and detect a contact position of a user; and
a control unit configured to control execution of a predetermined action if the contact position of the user detected by the touch panel unit is in a predetermined area;
wherein the control unit changes the predetermined area in accordance with a condition of whether or not the touch panel unit displays an image or a character.

5. An electronic device comprising:
a touch panel unit configured to display at least an image or a character and detect a contact position of a user; and
a control unit configured to control an action of the image pickup apparatus in accordance with the contact position of the user detected by the touch panel unit;
wherein the control unit changes an acceptable area for a contact operation of the user on the touch panel unit, in accordance with a condition of whether or not the touch panel unit displays an image or a character.

6. An electronic device comprising:
a touch panel unit configured to display at least an image or a character and detect a contact position of a user; and
a control unit configured to control execution of a predetermined action if the contact position of the user detected by the touch panel unit is in a predetermined area;
wherein the control unit sets the predetermined area to be large in a condition where the touch panel unit does not display an image or a character, as compared with the predetermined area set in a condition where the touch panel unit displays an image or a character.

7. The electronic device according to claim 6,
wherein the control unit changes the action, the execution of which is controlled, in accordance with the condition of whether or not the touch panel unit displays an image or a character.

8. The electronic device according to claim 6,
wherein the control unit determines whether or not an operation of the user is a predetermined operation on the basis of a continuous change in the contact position of the user detected by the touch panel unit, and in a condition where the touch panel unit does not display an image or a character, the control unit controls the execution of the predetermined action only if the operation of the user is the predetermined operation.
